(19) United States
(12) Patent Application Publication
(10) Pub. No.: US 2007/0254099 A1
(43) Pub. Date: Nov. 1, 2007

(54) Resist coating method, resist coating apparatus and storage medium

(75) Inventors: Kousuke Yoshihara, Koshi-shi (JP); Tomohiro Iseki, Koshi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Minato-ku (JP)

(21) Appl. No.: 11/495,730

(22) Filed: Jul. 31, 2006

(30) Foreign Application Priority Data
Apr. 28, 2006 (JP) 2006-126826

(51) Int. Cl. B05D 3/12; B05C 13/02

(52) U.S. Cl. 427/240; 118/52

(57) ABSTRACT

The present invention wets the front surface of a substrate with a solvent in advance, then accelerates the substrate to a first number of rotations lower than a range of the numbers of rotations where a turbulence occurs on the front surface of the substrate, and starts supply of a resist solution to the central portion of the substrate during the acceleration to thereby apply the resist solution while spreading the resist solution outward on the substrate. Thereafter, the substrate is decelerated to a second number of rotations to adjust the distribution of the film thickness of the resist solution within a plane, and accelerated to a third number of rotations lower than the first number of rotations and higher than the second number of rotations to shake off the remaining resist solution. According to the present invention, in application of the resist solution by spin coating, the consumption of the resist solution can be reduced and a high uniformity of the film thickness of the resist film within a plane can be obtained.

### BACKGROUND OF THE INVENTION

1. Field of the Invention

The present invention relates to a resist coating method, a resist coating apparatus and a storage medium each for coating a substrate such as a semiconductor wafer or the like with a resist solution.

2. Description of the Related Art

In the photolithography process in a manufacturing process of a semiconductor device, a resist coating treatment of forming a resist film on the front surface of the semiconductor wafer (hereinafter, referred to as a “wafer”) is performed, and a spin coating method is generally employed as the coating method. The spin coating method is a method of supplying a resist solution from a nozzle 11 onto the central portion of the front surface of the wafer W with the wafer W attached to a spin chuck 10 by suction as shown in FIG. 14, and rotating the spin chuck 10 at a high speed to spread the resist solution toward the outside in a radial direction of the wafer W by a centrifugal force.

To perform such a resist coating, it is necessary to apply the resist solution onto the wafer with a high uniformity within a plane. Further, in the spin coating method, most of the resist solution supplied on the wafer is shaken off and the resist solution is very expensive, and therefore it is important to reduce the supply amount of the resist solution onto the wafer.

Japanese Patent Application Laid-open No. H8-330206 describes that at the time when spin-coating the front surface of a substrate with a photoresist, the photoresist is dropped onto the substrate while the substrate is being rotated at a number of rotations higher than the number of rotations to form a film of the photoresist to spread over the front surface of the substrate, and then the number of rotations of the substrate is decreased to the number of rotations to form a film with a predetermined film thickness. It is described that the number of rotations higher than the number of rotations to form a film is, for example, the number of rotations during acceleration. More specifically, this prior art document describes that the resist solution is dropped onto the wafer while the wafer is accelerated to the number of rotations higher than the number of rotations to cause a turbulence, for example, 7000 rpm, and the wafer is decelerated to about 3000 rpm that is the number of rotations to form a film immediately after completion of the drop.

However, when the resist solution is applied to the wafer during increase in the number of rotations, the resist solution does not smoothly spread on the front surface of the wafer and tends to cause streaks in the solution film because the number of rotations is small at the initial stage of starting the supply of the resist solution. Once the streaks appear, the resist solution is apt to spread along the streaks even if the number of rotations is increased, resulting in occurrence of unevenness in coating. As a result, such a technique is far from an employable method.

Besides, Japanese Patent Application Laid-open No. H11-260717 describes that a standing-still wafer is pre-wetted with a thinner, then rotated at 4500 rpm (3500 rpm in an actual experiment) that is a first number of rotations, and then decelerated to 500 rpm that is a second number of rotations, and further rotated at 3000 rpm that is a third number of rotations. In this method, the resist is more prone to spread because the front surface of the wafer has been pre-wetted with the thinner, with the result that a uniform resist film could be formed with a small amount of resist solution.

Incidentally, since miniaturization of the pattern of the semiconductor device and reduction in film thickness are required, various resist solutions adaptable to such photolithography are developed. However, the cost of the resist solutions is rising more than before because the resist solutions are required to have precise physical properties, so that the resist solutions are very expensive in the present circumstances. Therefore, the consumption of the resist needs to be further reduced, and accordingly a coating method is desired which can save the resist more than before and secure a high uniformity of the film thickness within a plane.

### SUMMARY OF THE INVENTION

The present invention has been developed in such circumstances and its object is to provide a technique capable of reducing the consumption of a resist solution and providing a high uniformity of the film thickness of the resist film within a plane in application of the resist solution by spin-coating.

A resist coating method of the present invention includes the steps of: supplying a front surface of the substrate with a liquid agent for wetting the front surface and rotating the substrate; subsequently accelerating the substrate to a first number of rotations, and starting supply of the resist solution to a central portion of the substrate during the acceleration to thereby apply the resist solution while spreading the resist solution outward on the substrate; decelerating the substrate to a second number of rotations after the number of rotations of the substrate reaches the first number of rotations, and rotating the substrate at the second number of rotations to thereby adjust a distribution of the film thickness of the resist solution within a plane; stopping the supply of the resist solution at a timing when a supply amount of the resist solution while the substrate is accelerated to the first number of rotations becomes 80% or more of a total supply amount; and thereafter, accelerating the substrate to a third number of rotations higher than the second number of rotations, and rotating the substrate at the third number of rotations to thereby dry a resist film.

In this case, it is also adoptable to decelerate the substrate to the third number of rotations instead of decelerating the substrate to the second number of rotations after the number of rotations of the substrate reaches the first number of rotations, and to rotate the substrate at the third number of rotations to thereby dry a resist film; and to stop the supply of the resist solution at a timing when a supply amount of the resist solution while the substrate is accelerated to the first number of rotations becomes 80% or more of a total supply amount.

Note that the third number of rotations may be lower or higher than the first number of rotations.

According to another aspect, the present invention is a resist coating apparatus for coating a substrate with a resist solution including: a substrate holding unit for horizontally holding the substrate; a rotation drive unit for rotating the substrate holding unit about a vertical axis; a liquid agent supply unit for supplying a liquid agent for wetting a front surface of the substrate to the substrate held by the substrate holding unit via a liquid agent nozzle; a resist solution supply unit for supplying a resist solution via a resist solution nozzle to a central portion of the substrate held by the substrate holding unit; and a controller for controlling the rotation drive unit, the liquid agent supply unit, and the resist solution supply unit. The controller controls the rotation drive unit, the liquid agent supply unit, and the resist solution supply unit to execute a step of supplying a front surface of the substrate with the liquid agent for wetting the front surface and rotating the substrate; a step of subsequently accelerating the substrate to a first number of rotations, and starting supply of the resist solution to the central portion of the substrate during the acceleration to thereby apply the resist solution while spreading the resist solution outward on the substrate; a step of decelerating the substrate to a second number of rotations after the number of rotations of the substrate reaches the first number of rotations, and rotating the substrate at the second number of rotations to thereby adjust a distribution of the film thickness of the resist solution within a plane; a step of stopping the supply of the resist solution at a timing when a supply amount of the resist solution while the substrate is accelerated to the first number of rotations becomes 80% or more of a total supply amount; and a step of thereafter, accelerating the substrate to a third number of rotations higher than the second number of rotations, and rotating the substrate at the third number of rotations to thereby dry a resist film.

In this case, it is also adoptable that the controller controls the rotation drive unit, the liquid agent supply unit, and the resist solution supply unit to execute a step of decelerating the substrate not to the second number of rotations but to the third number of rotations after the number of rotations of the substrate reaches the first number of rotations, and rotating the substrate at the third number of rotations to thereby dry a resist film; and a step of stopping the supply of the resist solution at a timing when a supply amount of the resist solution while the substrate is accelerated to the first number of rotations becomes 80% or more of a total supply amount.

The above-described processes of the resist coating method may be stored as a computer program to cause a resist coating apparatus to execute.

According to the above-described embodiment, the front surface of the substrate is wetted with the solvent in advance to make the resist solution to easily diffuse, and subsequently all or most of the resist solution is applied during acceleration of the rotation of the substrate, so that the resist solution spreads with a high uniformity. As is clear also from the evaluation experiment, the resist solution can be efficiently spread to the outer periphery of the substrate. Accordingly, the consumption of the resist solution can be reduced as compared to the prior art. In other words, it is possible to perform coating treatment with a high uniformity of the film thickness within a plane even with a small amount of resist solution.

### BRIEF DESCRIPTION OF THE DRAWINGS

FIG. 1 is a schematic cross-sectional view showing a resist coating apparatus according to an embodiment of the present invention;

FIG. 2 is a schematic plan view showing the resist coating apparatus according to the embodiment of the present invention;

FIG. 3 is an explanatory view showing one example of the recipe in which a profile of the number of rotations of a wafer and the timing of supply of a resist solution are correlated with each other in the embodiment of the present invention;

FIG. 4 is an operation explanatory view schematically showing the states at respective timings of the recipe shown in FIG. 3;

FIG. 5 is an explanatory view showing patterns of film thickness distributions of the resist solution;

FIG. 6 is an explanatory view schematically showing an appearance in which the outer peripheral portion of the resist solution on the front surface of the wafer decreases in size outward;

FIG. 7A and FIG. 7B are explanatory views showing that the outer peripheral portions of the resist solution differently spread due to difference in centrifugal force;

FIG. 8 is an explanatory view showing another example of the recipe in which a profile of the number of rotations of the wafer and the timing of supply of the resist solution are correlated with each other in the embodiment of the present invention;

FIG. 9 is an explanatory view showing still another example of the recipe in which a profile of the number of rotations of the wafer and the timing of supply of the resist solution are correlated with each other in the embodiment of the present invention;

FIG. 10 is an explanatory view showing a comparative example of the recipe in which a profile of the number of rotations of the wafer and the timing of supply of the resist solution are correlated with each other;

FIG. 11 is a measured drawing of film thickness distributions of the resist solution;

FIG. 12 is a plan view showing a coating and developing apparatus in which the resist coating apparatus of the present invention is incorporated;

FIG. 13 is a schematic configuration view showing the coating and developing apparatus; and

FIG. 14 is an explanatory view showing an appearance of the dropped resist solution spreading on the front surface of the wafer in the conventional example.

### DETAILED DESCRIPTION OF THE PREFERRED EMBODIMENT

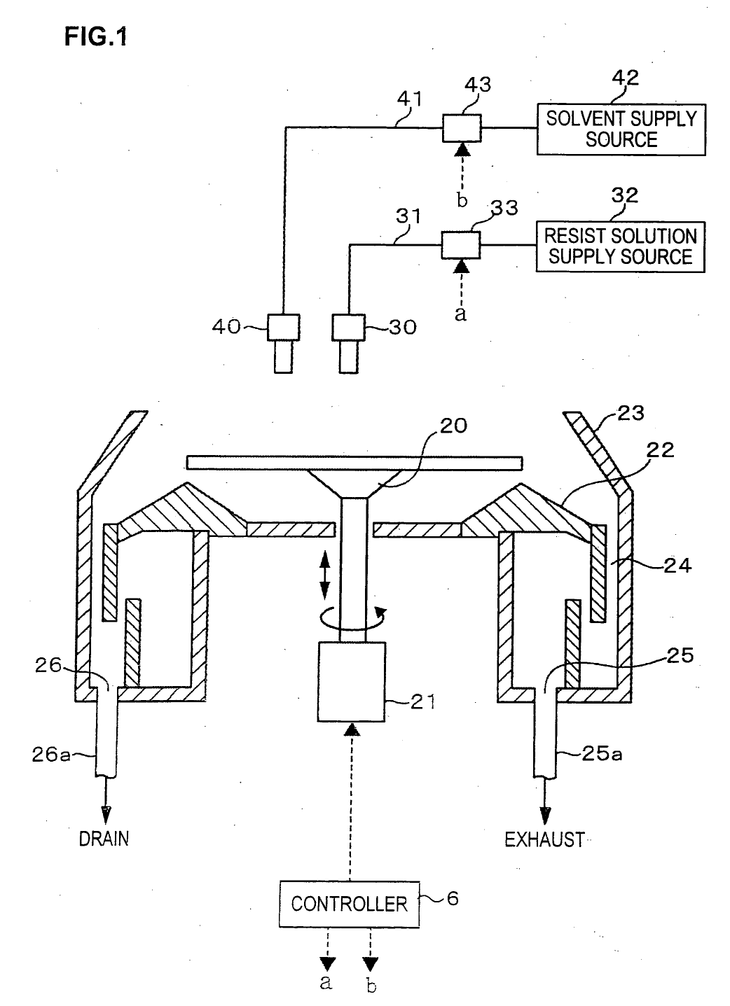

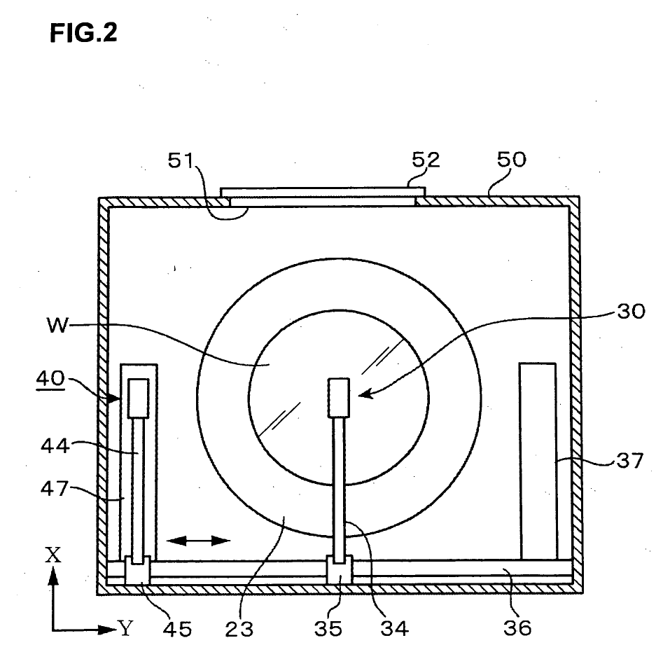

A resist coating apparatus according to an embodiment of the present invention will be described with reference to FIG. 1 and FIG. 2. Numeral 20 in FIG. 1 denotes a spin chuck, which forms a substrate holding unit, is configured to horizontally hold a wafer W by vacuum suction. The spin chuck 20 can rotate around the vertical by means of a rotation drive unit 21 including a motor and so on and can rise and lower. A guide ring 22 having a cross section in an angle shape is provided below the spin chuck 20, and the outer periphery of the guide ring 22 extends bending downward. A cup body 23 is provided in a manner to surround the spin chuck 20 and the guide ring 22.

The cup body 23 is formed at its upper surface with an opening larger than the wafer W so that the spin chuck 20 can rise and lower, and formed with a gap 24 forming a drainage path between its side peripheral surface and the outer periphery of the guide ring 22. The lower portion of the cup body 23 forms a bending path in conjunction with the outer peripheral portion of the guide ring 22 to constitute a gas/liquid separating section. An exhaust port 25 is formed at an inner side area of the bottom portion of the cup body 23, and an exhaust pipe 25a is connected to the exhaust port 25. Further, a drain port 26 is formed at an outer side area of the bottom portion of the cup body 24, and a drain pipe 26a is connected to the drain port 26.

The resist coating apparatus also includes a resist solution nozzle 30 for supplying a resist solution onto the central portion of the front surface of the wafer W and a solvent nozzle 40 for supplying a liquid agent, for example, a solvent (thinner) to the central portion of the front surface of the wafer W. The resist solution nozzle 30 is connected to a resist solution supply source 32 for supplying the resist solution via a resist solution supply pipe 31. Along the resist solution supply pipe 31, a supply equipment group 33 is also provided including a valve, a flow control unit and so on. The solvent nozzle 40 is connected to a solvent supply source 42 for supplying the solvent, for example, the thinner via a solvent supply pipe 41. Along the solvent supply pipe 41, a supply equipment group 43 is also provided including a valve, a flow control unit and so on. In this embodiment, the resist solution supply source 32 and the supply equipment group 33 correspond to a resist solution supply unit, and the solvent supply source 42 and the supply equipment group 43 correspond to a solvent supply unit.

The resist solution nozzle 30 is connected, as shown in FIG. 2, to a moving mechanism 35 via an arm 34 bent in an L-shape. The arm 34 is configured to be able to move along a guide rail 36 provided along the length direction (Y-direction) of a treatment container 50 by means of the moving mechanism 35 from a waiting region 37 provided outside on one end side (right side in FIG. 2) of the cup body 23 to the other end side and move in the vertical direction.

The solvent nozzle 40 is connected, as shown in FIG. 2, to a moving mechanism 45 via an arm 44 bent in an L-shape. The arm 44 can move along the guide rail 36 by means of the moving mechanism 45 from a waiting region 47 provided outside on the other end side (left side in FIG. 2) of the cup body 23 to the one end side and move in the vertical direction. A carry-in/out port 51 for the wafer W is formed in a surface of the side wall of the treatment container 50 facing a carry-in region of a carrier arm being a carrier means, and an opening/closing shutter 52 is provided at the carry-in/out port 51.

The resist coating apparatus includes, as shown in FIG. 1, a controller 6 having a computer program for controlling a later-described series of operations, and the controller 6 is configured to control the rotation drive unit 21, the supply equipment groups 33 and 43, and so on. The computer program is stored in a storage medium, for example, a flexible disk (FD), a memory card, a compact disk (CD), a magneto-optical disk (MO), a hard disk, or the like and installed in a computer being the controller 6.

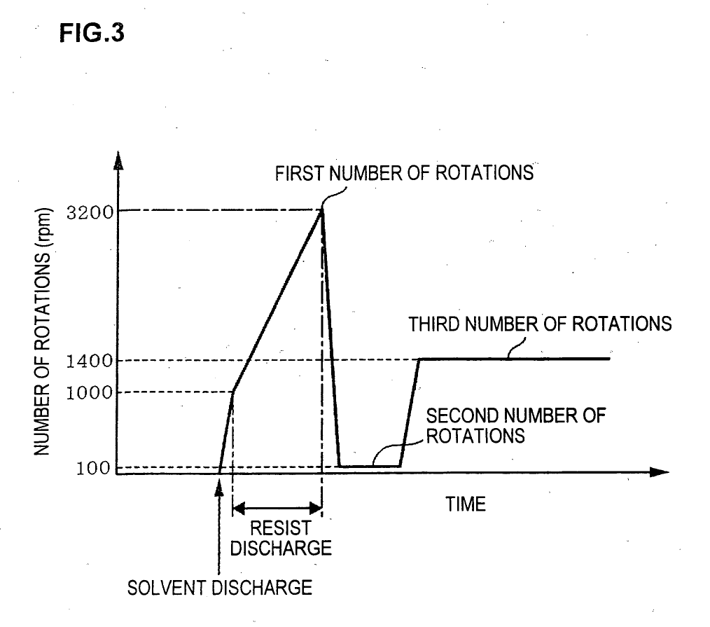

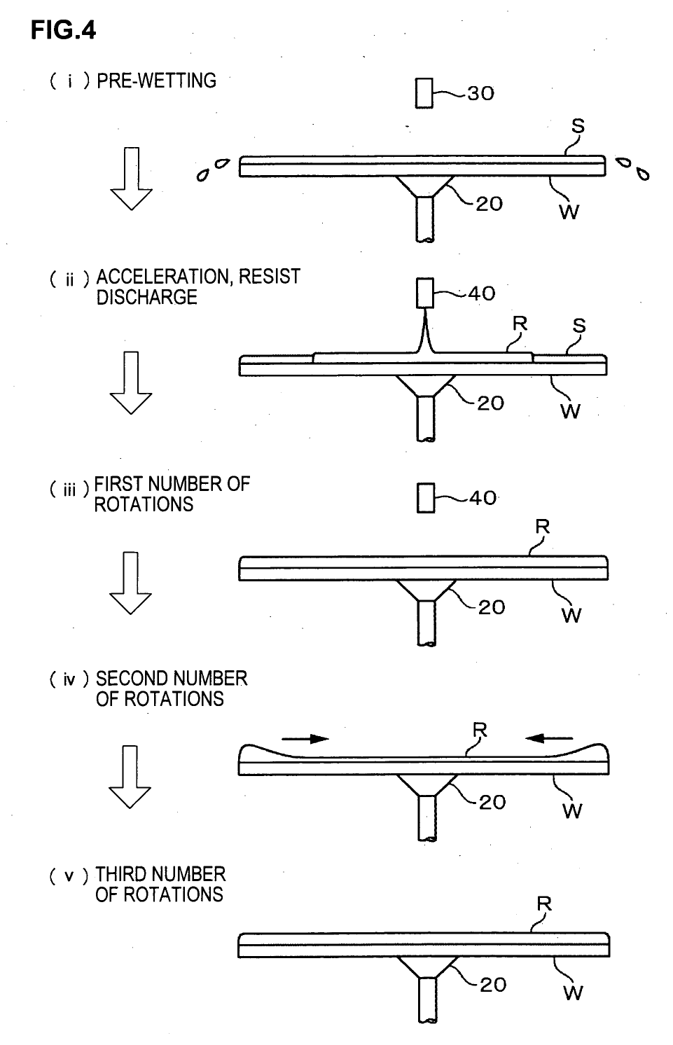

Next, the operation of the above-described embodiment will be described. FIG. 3 shows a profile (recipe) of the number of rotations of the wafer W according to the coating method of this embodiment of the present invention, and FIG. 4 schematically illustrates the states of a solution film on the front surface of the wafer at respective timings shown in FIG. 3. Note that the time lengths of respective processes in FIG. 3 do not always correspond to the actual time lengths for easy understanding of the technology.

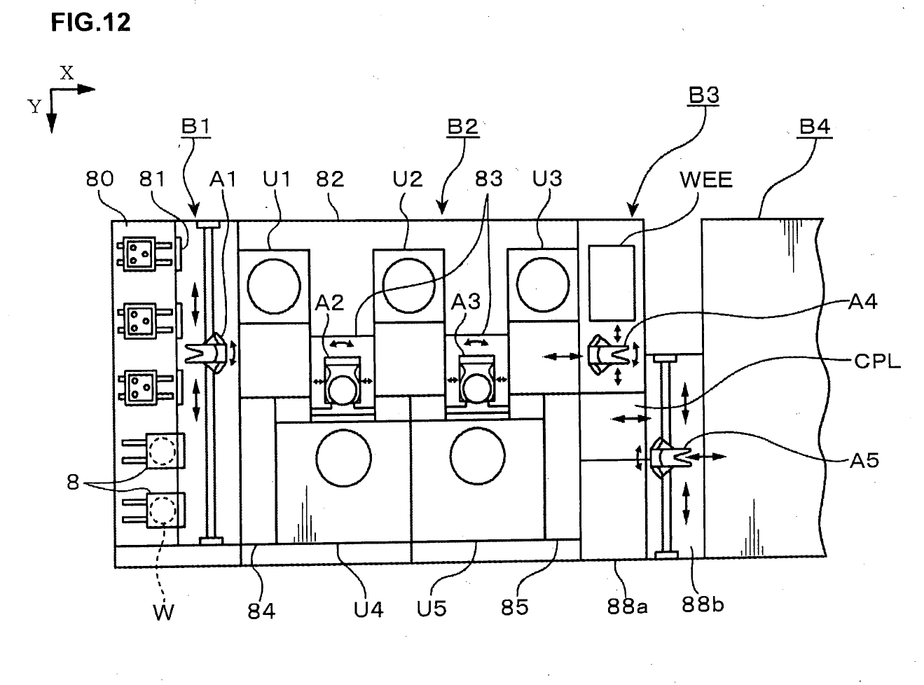

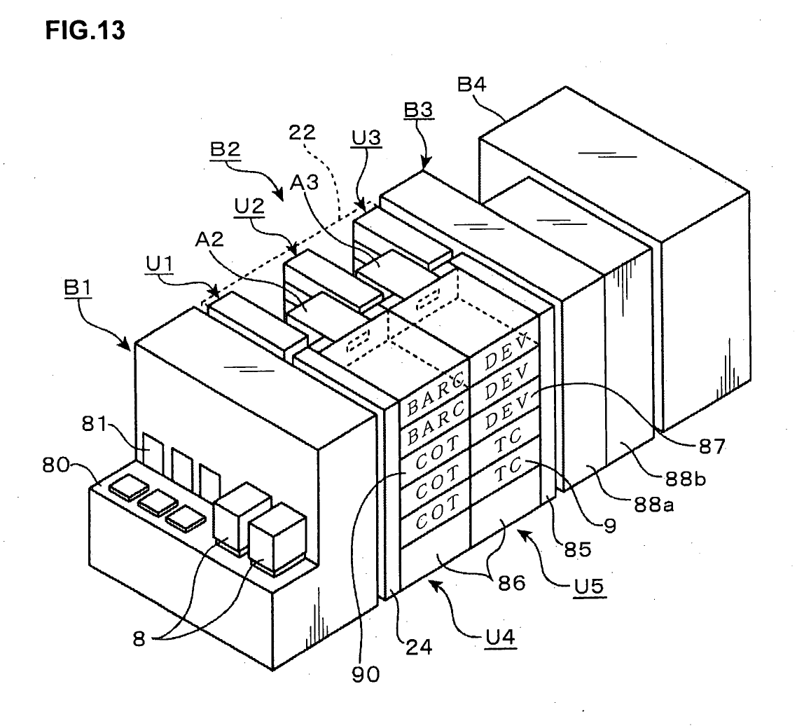

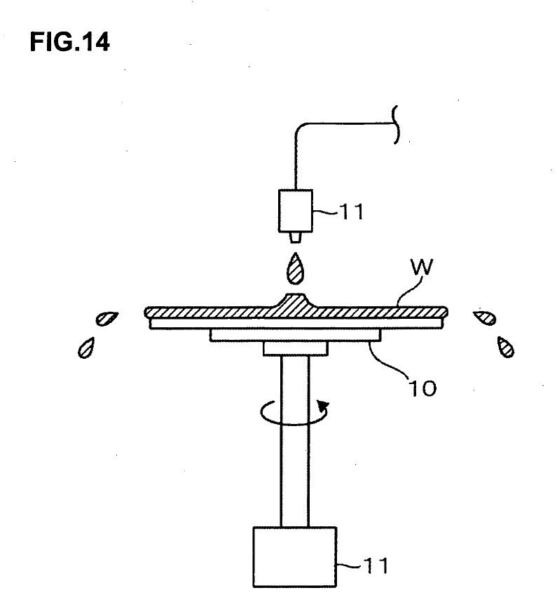

First of all, an external carrier arm holding the wafer W (for example, a carrier arm A2 or A3 in FIG. 12) outside the resist coating apparatus enters the container 50 via the carry-in/out port 51 (see FIG. 2) and transfers a 12-inch size wafer W to the spin chuck 30 therefrom. This transfer may be performed by raising the spin chuck 20 or by using not-shown raising and lowering pins. The wafer W is held on the spin chuck 20 by suction, and the solvent nozzle 40 moves to a position above the central portion of the wafer W and supplies, for example, 2.0 ml of the solvent (thinner) being a liquid agent onto the central portion of the standing-still wafer W therefrom.

Subsequently, the solvent nozzle 40 is moved from the position above the central portion of the wafer W, and instead, the resist nozzle 30 is moved to a position above the central portion of the wafer W, and the wafer W is rotated by controlling the rotation drive unit 21 whose rotation speed is increased to 1000 rpm at an acceleration of 10000 rpm/sec. At the point in time when the number of rotations reaches 1000 rpm, the resist nozzle 30 starts to discharge the resist solution onto the central portion of the wafer W, and the number of rotations is increased to 3200 rpm at an acceleration of 1500 rpm/sec.

The states on the front surface of the wafer W so far are shown at (i) and (ii) in FIG. 4, in which the time required for the number of rotations of the wafer W to reach 1000 rpm is 0.1 seconds, so that the wafer is rotated at 1000 rpm in a moment. Therefore, the solvent supplied on the central portion of the wafer W is spread outward, that is, pre-wetting is performed, whereby the front surface of the wafer W becomes wet with the solvent. Then, from this point in time, the resist solution is dropped onto the central portion of the wafer W, so that the resist solution is smoothly diffused without any trouble to cause no unevenness in coating due to spreading in streaks. In addition, the number of rotations of the wafer W is further increased, and the resist solution continues to be dropped onto the central portion of the wafer W during the increase (during acceleration). The time required for the number of rotations of the wafer W to increase from 1000 rpm and reach 3200 rpm is 1.47 seconds, while the resist nozzle 40 discharges 0.5 ml of the resist solution in 1.5 seconds. This results in that all the resist solution will be supplied onto the front surface of the wafer W substantially during the acceleration of the wafer W in consideration of operation error of the mechanism parts of the apparatus.

At the time when the number of rotations of the wafer W reaches 3200 rpm, the resist solution has been spread with a high uniformity within the entire surface as shown at (iii) in FIG. 4. After the number of rotations reaches 3200 rpm, the control shifts to a deceleration state in a moment, in which the rotation is decelerated to a second number of rotations. The reason of such deceleration is to adjust the distribution of film thickness within a plane by bringing the rotation to a low speed before drying up of the resist solution, since the resist solution dries up if the high speed rotation is maintained after the resist solution is spread without unevenness over the wafer W. In other words, at the time when the resist solution is applied onto the front surface of the wafer W at the first number of rotations, precisely the film thickness is larger on the outer peripheral portion side of the wafer W. Thus, the rotation is brought to the low speed at which drying hardly proceeds before the resist solution dries up, that is, the resist solution still has flowability, whereby the resist solution building-up on the outer peripheral portion side is drawn toward the central portion, resulting in uniformity in film thickness (at (iv) in FIG. 4).

Therefore, it is preferable to perform the deceleration as soon as possible, in which the rotation is decelerated to the second number of rotations, for example, to 100 rpm, for example, at an acceleration (a negative acceleration) of 30000 rpm/sec. The time required to reduce the speed from the first number of rotations to the second number of rotations is preferably, for example, within 0.2 seconds. Note that the second number of rotations is not limited to 100 rpm, but is preferably 1000 rpm or less. Besides, the time in which the second number of rotations is maintained is, for example, 1 second, and may be adjusted depending on the viscosity of the resist solution.

The completion time point of resist discharge may be before the first number of rotations is reached, and is desirably the time point as close as possible to that of the first number of rotations in viewpoint of decreasing the amount of the resist. Further, since it is disadvantageous to discharge the resist solution during the deceleration from the first number of rotations to the second number of rotations as a result of a later-described evaluation experiment, it is preferable that the completion time point of resist discharge does not overlap the deceleration step. However, it is conceivable that even if it is unavoidable that the discharge of the resist solution slightly overlaps the deceleration step due to the operation error of hardware parts, it is necessary to stop the supply of the resist solution at a timing when the supply amount of the resist solution while the wafer W is accelerated to the first number of rotations is 80% or more of the total supply amount, in order to achieve the effects of the present invention. Note that, for implementation of the present invention, there is no conceivable advantage of creating a recipe for positive discharge of the resist solution in the deceleration step, but it is also within the technical scope of the present invention that the supply amount of the resist solution while the rotation is accelerated to the first number of rotations is 80% or more of the total supply amount.

After the wafer is rotated at the second number of rotations, the number of rotations of the wafer W is increased, for example, to a third number of rotations lower than the first number of rotations and maintained at the third number of rotations for a while, for example, for 20 seconds. The reason why the wafer W is rotated at the third number of rotations is to dry the resist film by the rotation, in which the remaining resist solution is also shaken off so that the film thickness is adjusted. The third number of rotations and its duration are determined depending on the target film thickness, the viscosity of the resist solution and so on, and the rotation number for the 12-inch size wafer is preferably 2000 rpm or less and is set, for example, to 1000 rpm to 1800 rpm. The wafer W is thereafter subjected to rinse treatment for its rear surface and then transferred to the external carrier arm by the operation reverse to that for the above-described carrying-in.

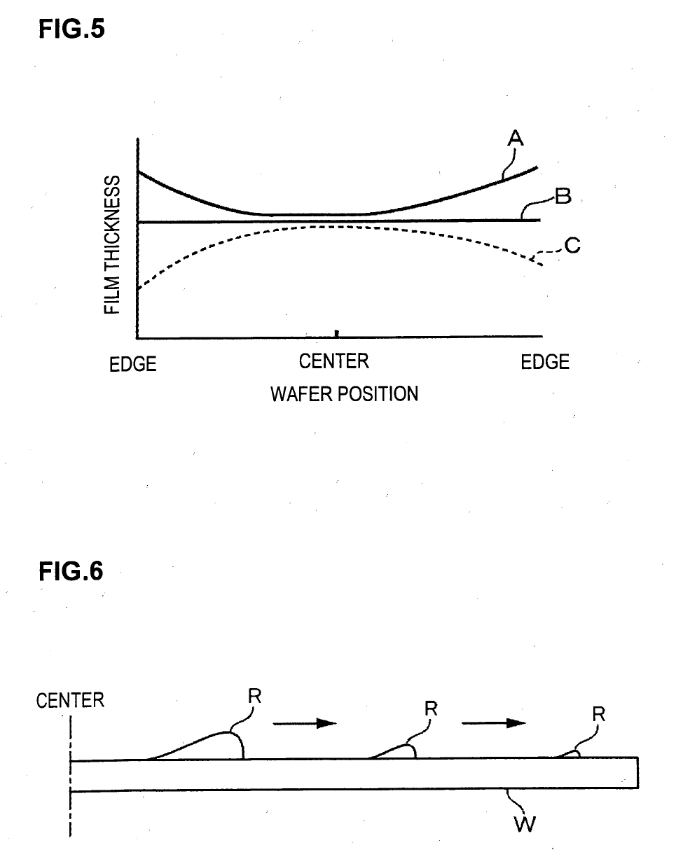

Here, the method of supplying the resist solution to the wafer W during the first number of rotations as in Japanese Patent Application Laid-open No. H11-260717 and the method of the present invention of supplying the resist solution to the wafer W during the acceleration to the first number of rotations are compared. When the supply amount of the resist solution is set to a certain amount now, the present invention provides a film thickness distribution in which the film thickness at the peripheral portion of the wafer W is larger as shown at A in FIG. 5, whereas Japanese Patent Application Laid-open No. H11-260717 provides a film thickness distribution in which the film thickness is uniform on the entire surface as shown at B in FIG. 5. The above facts mean the following.

Namely, if the film thickness at the peripheral portion is larger than that at the central portion, the film thickness can be uniformed within a plane by reducing the discharge amount of the resist solution, by adjusting the first number of rotations, or by adjusting the time for rotation at the second number of rotations. On the other hand, the fact that the film thickness on the entire surface becomes uniform means impossibility of further adjustment, in other words, indicates the limit in reducing the amount of the resist. If the amount of the resist is further reduced, the film thickness at the peripheral portion will become smaller than that at the central portion as shown by a dotted-line C in FIG. 5. Accordingly, even if the amount of the resist solution is reduced to be smaller than that in the method of Japanese Patent Application Laid-open No. H11-260717, the present invention still provides a high uniformity within a plane in film thickness.

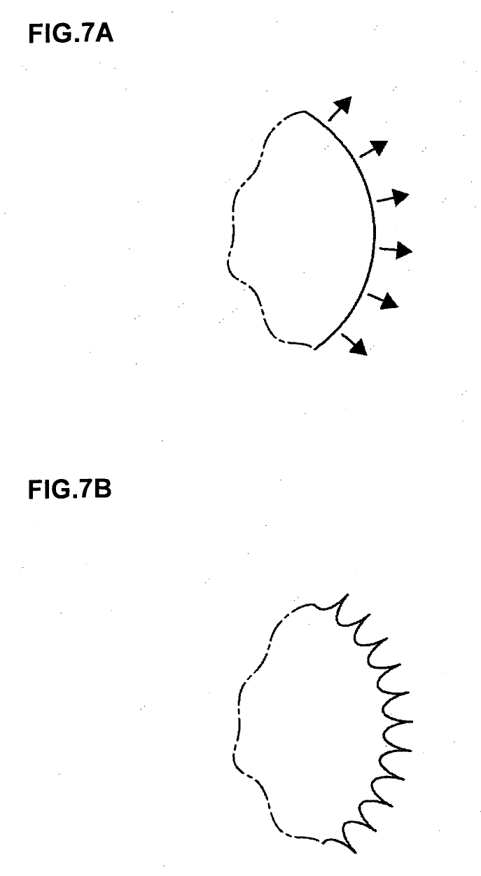

The inventors consider the reason of the above as follows. In the case where the resist solution is discharged to the central portion of the rotating wafer W, when the resist solution on the wafer W is regarded a set of ring-shape portions, aggregations R of the solution in the ring-shape portions (a symbol R for the aforementioned resist solution is given for convenience) as shown in FIG. 6 gradually decrease in size from the central portion toward the peripheral portion. Thus, if the amount of solution is too small, the aggregations R break into line shapes due to the centrifugal force and accordingly into streaks. FIG. 7A and FIG. 7B schematically show the appearances of the resist solution spreading for the case where the aggregation R of the resist solution does not break and for the case where the aggregation R breaks, respectively. If the resist solution is supplied to the wafer W during the first number of rotations as in Japanese Patent Application Laid-open No. H11-260717, the solution breaking phenomenon occurs when the discharge amount of the resist solution is reduced. On the other hand, it is believed that if the resist solution is supplied during the acceleration as in the present invention, the aggregation R of the solution moves to the peripheral portion of the wafer W as it is still large (as the solution thickness is still large) because the number of rotations of the wafer W is still small during supply of the resist solution, with the result that even a small amount of solution is insusceptible to the solution breaking phenomenon.

Besides, the point in time of starting discharge of the resist solution is preferably the time point when the number of rotations of the wafer W is smaller than the third number of rotations. The reason therefor is as follows. The third number of rotations is within the range of the numbers of rotations where the remaining resist solution is shaken off and drying proceeds, and is determined depending on the viscosity of the resist solution in use. Accordingly, if the number of rotations is higher than the third number of rotations, evaporation of the solvent used for pre-wetting proceeds so that the wettability on the entire surface of the wafer W becomes hard to be secured, which degrades the effect of the pre-wetting, thereby causing unevenness in coating of the resist solution to tend to occur.

According to the above-described embodiment, the front surface of the wafer W is wetted with the solvent in advance to make the resist solution to easily diffuse, and subsequently all or most of the resist solution is applied during acceleration of the rotation of the wafer W, so that the resist solution spreads with a high uniformity with the result that unevenness in coating hardly occurs. As is clear also from the later-described evaluation experiment, the resist solution can be efficiently spread to the outer periphery of the wafer W to reduce the consumption of the resist solution as compared to the case where the resist solution is supplied onto the wafer W while the substrate is being rotated at the first number of rotations (as compared to the method in Japanese Patent Application Laid-open No. H11-260717). In other words, the method according to the embodiment can perform coating treatment with a high uniformity of the film thickness within a plane even with a small amount of resist solution, and therefore is a method suitable for manufacturing a semiconductor device for which miniaturization of the pattern, reduction in film thickness, and increase in cost of the resist solution are advanced.

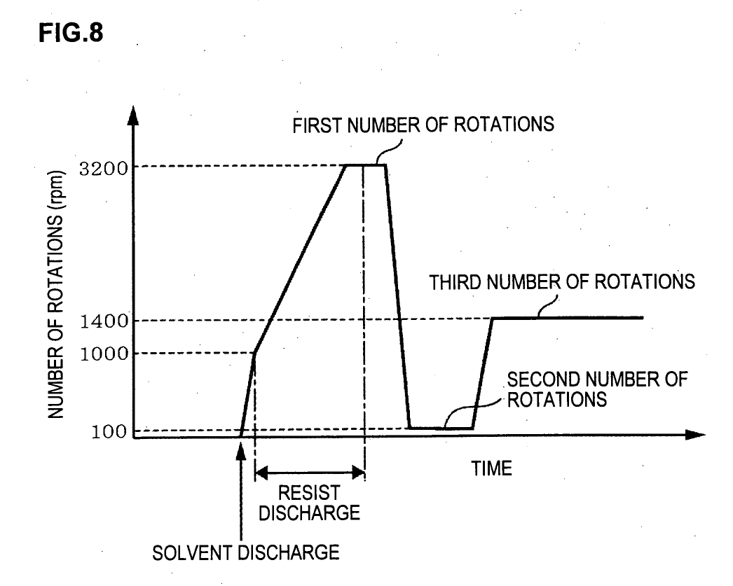

In the present invention, the rotation of the wafer W is not limited to that the rotation is decelerated to the second number of rotations immediately after the number of rotations of the wafer W reaches the first number of rotations, but the first number of rotations may be maintained for a while. However, if the supply to the wafer W is completed concurrently with the time when the first number of rotations is reached as in the above embodiment, it is preferable to decelerate the rotation to the second number of rotations immediately after it reaches the first number of rotations. The example shown in FIG. 8 shows the case where the first number of rotations is maintained for a while and the discharge of the resist solution is continued for a while after the first number of rotations is reached. If the supply of the resist solution is continued until after the first number of rotations is reached as described above, it is preferable to decelerate the rotation to the second number of rotations, for example, within 0.2 seconds after the supply of the resist solution is stopped. It should be noted that if the supply of the resist solution is stopped at the midpoint of the acceleration to reach the first number of rotations or upon reaching the first number of rotations, it is preferable to decelerate the rotation to the second number of rotations, for example, within 0.2 seconds from the point in time when it reaches the first number of rotations. Note that the third number of rotations subsequent to the second number of rotations is not limited to be lower than the first number of rotations, but may be higher than that.

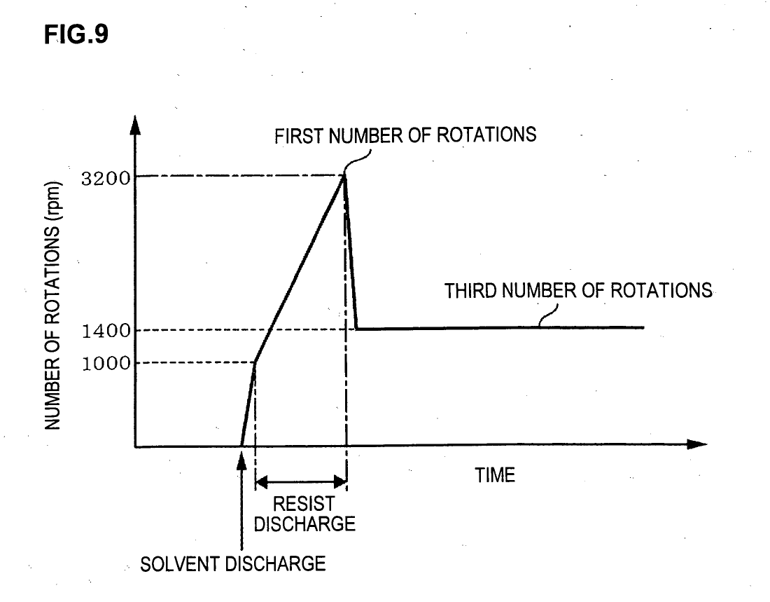

Furthermore, if the uniformity of the film thickness of the resist solution within a plane is high at the point in time when the discharge of the resist solution is completed, the rotation of the wafer W does not always need to be decelerated to the second number of rotations, but may be decelerated to the third number of rotations as shown in FIG. 9 in which the step of decelerating the rotation to the second number of rotations may be omitted.

It should be noted that the first number of rotations is preferably 4000 rpm or less and more preferably 1500 rpm to 3500 rpm for the 12-inch size wafer W. The first number of rotations is preferably 6000 rpm or less and more preferably 3000 rpm to 5000 rpm for the 8-inch size wafer W. Further, the third number of rotations is preferably 4000 rpm or less for the 8-inch size wafer W.

### EXPERIMENTAL EXAMPLES

Evaluation experiments for confirming the effects of the present invention will be described next. As recipes for the numbers of rotations and application of the resist solution, three examples, such as Example 1, Comparative Example 1, and Comparative Example 2 were prepared as follows.

### Example 1

Example 1 is as shown in FIG. 3 being the already described embodiment.

### Comparative Example 1

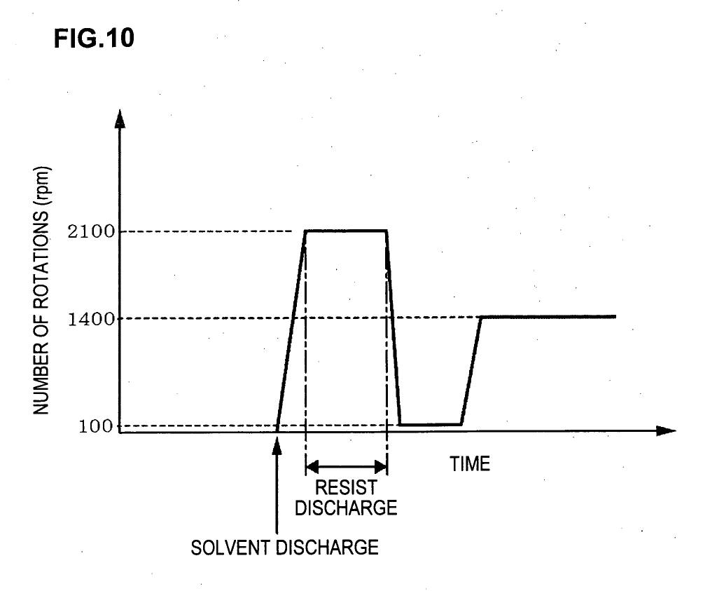

As shown in FIG. 10, the same recipe as that of Example 1 was employed except that the first number of rotations was 2100 rpm (the meaning of the number of rotations will be described later), the first number of rotations was maintained for 1.5 seconds, and 0.5 ml of the resist solution was supplied onto the wafer W for that 1.5 seconds, and that pre-wetting was performed and the rotation was increased up to the first number of rotations at an acceleration of 10000 rpm/sec, in the recipe for Example 1.

### Comparative Example 2

In Example 1, the rotation was decelerated from the first number of rotations to 1000 rpm at an acceleration of 1500 rpm/sec during which the resist solution was supplied to the wafer W, and the rotation was then decelerated to the second number of rotations at an acceleration of 30000 rpm/sec. The recipe other than the above was the same as that for Example 1.

### Experimental Results

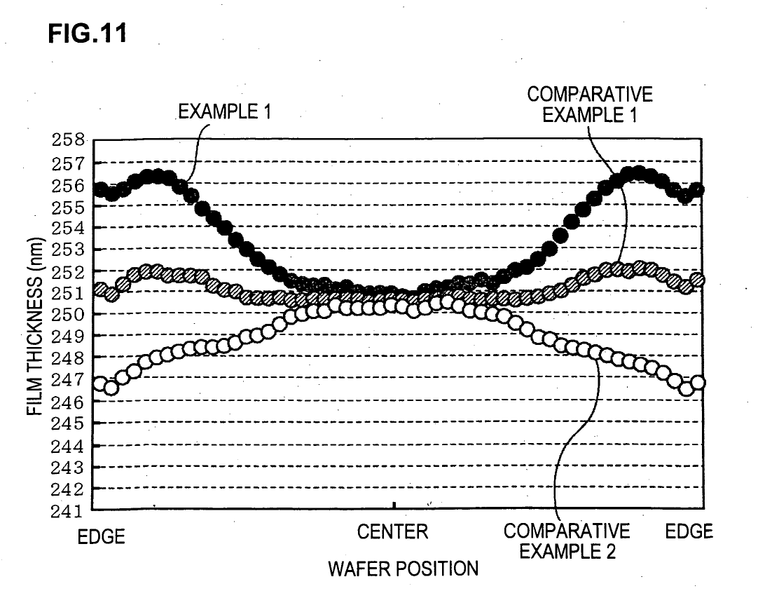

Checking the film thickness distributions of the resist films on the wafer W after the respective recipes were completed shows the results shown in FIG. 11. It should be noted that it has been experientially grasped that, for performance of such experiments, the coating states cannot be accurately compared, that is, the evaluation of the recipes cannot be precisely performed unless values obtained by integrating the numbers of rotations with respect to time in a time zone when the resist solution is being discharged (for example, the area in the resist discharge time zone in FIG. 10) are made match each other, and therefore the first number of rotations is set to 2100 rpm in Comparative Example 1 based on the above point.

The above results shows that the film thickness at the peripheral portion of the wafer W was larger than that at the central portion in the present invention, whereas the film thickness was uniform over the entire surface of the wafer W in Comparative Example 1 in which the resist solution was supplied while the wafer W was being rotated at the first number of rotations. Accordingly, there was already no margin in Comparative Example 1 as described above and, as a result, it is found that the resist solution can be further reduced in amount in the present invention. Note that the film thickness at the peripheral portion of the wafer W was smaller than that at the central portion in Comparative Example 2 in which the resist solution was supplied during deceleration, which shows that application of the resist solution with a high uniformity within a plane cannot be achieved with 0.5 ml of resist solution.

### Application Example of Resist Coating Apparatus

Subsequently, the whole configuration of a coating and developing apparatus in which the above-described resist coating apparatus is incorporated and to which an aligner is connected will be briefly described with reference to FIG. 12 and FIG. 13. In FIG. 12 and FIG. 13, symbol B1 denotes a carrier station for carrying-in/out a carrier 8 hermetically housing a plurality of substrates, for example, 13 substrates, and a mounting section 80 capable of mounting a plurality of carriers 8 arranged side by side thereon, an opening/closing units 81 provided in the wall surface on the front side as viewed from the mounting section 80, and a transfer means A1 for taking the wafers W from the carriers 8 via the opening/closing units 81, are provided in the carrier station B1.

To the rear side of the carrier station B1, a processing block B2 is connected which is surrounded by a housing 82, and shelf units U1, U2 and U3 in each of which units of heating and cooling systems are multi-tiered and main arms A2 and A3 forming substrate carrier means for transferring the wafer W between the units in shelf units U1, U2 and U3 and solution treatment units U4 and U5 are provided arranged alternately in sequence from the front side in the processing block B2. Further, each of the main arms A2 and A3 is placed in a space surrounded by a partition wall 83 composed of face portions on the side of the shelf units U1, U2, and U3 which are arranged in a forward and backward direction as viewed from the carrier station B1, one face portion on the side of, for example, the later-described solution treatment unit U4 or U5 on the right side, a rear face portion forming one face on the left side. Numerals 84 and 85 in FIG. 12 and FIG. 13 denote temperature and humidity regulating units each comprising a temperature regulator, a duct for regulating the temperature and humidity and so on for treatment solutions used in the units.

The solution treatment units U4 and U5 are configured such that the above-described resist coating apparatuses (COT) 90 for applying the resist solution to the front surface of the wafer W, developing units (DEV) 87 for applying a developing solution to front surface of the wafer W, antireflection film forming units (BARC) and so on are multi-tiered, for example, five-tiered on chemical storage unit 86 for the resist solution, the developing solution and so on, for example, as shown in FIG. 13. Besides, the already-described shelf units U1, U2, and U3 are configured such that various kinds of units for performing pre-processing and post-processing of the treatments performed in the solution treatment units U4 and U5 are multi-tiered, for example, ten-tiered, in which the combination of the units includes a heating unit for heating (baking) the wafer W, a cooling unit for cooling the wafer W, and soon.

To the rear side of the shelf unit U3 in the processing block B2, an aligner B4 is connected via an interface section B3 composed of a first carrier chamber 88a and a second carrier chamber 88b. Inside the interface section B3, an edge exposure unit (WEE) for selectively exposing only an edge portion of the wafer W, a buffer cassette (SBU) for temporarily housing a plurality of, for example, 25 wafers W, a transfer unit (TRS 2) for transferring the wafer W, a high-precision temperature regulating unit (CPL), for example, having a cooling plate and so on are provided in addition to two transfer means A4 and A5 for transferring the wafer W between the processing block B2 and the aligner B4.

Taking an example of the flow of the wafer W in this apparatus, when the carrier 8 housing wafers W is carried in from the outside and mounted on the mounting table 80, the lid body of the carrier 8 is removed together with the opening/closing unit 81, and a wafer W is taken out by the transfer means A1. The wafer W is transferred via a transfer unit (not shown) forming one tier in the shelf unit U1 to the main carrier means A2 and subjected, for example, to hydrophobic treatment and cooling processing as the pre-processing of the coating treatment in one shelf in one of the shelf units U1 to U3. Thereafter, the resist solution is applied to the front surface of the wafer W in the resist coating apparatus (COT) 90, and a water-repellent protection film is then formed on the front surface of the wafer W having the resist film formed thereon in a protection film forming unit (TC) 3 being a protection film forming section. Subsequently, the wafer W is heated (baking processing) in the heating unit (PAB) forming one tier in one of the shelf units U1 to U3, then cooled, and carried via the transfer unit (TRS 1) in the shelf unit U3 into the interface section B3. In the interface section B3, the wafer W is carried by the transfer means A4, for example, to the edge exposure unit (WEE), to the buffer cassette (SBU), and to the high-precision temperature regulating unit (CPL), and the wafer W mounted on the high-precision temperature regulating unit (CPL) is carried by the transfer means A5 to the aligner B4 where the wafer W is subjected to exposure processing. The exposed wafer W is carried by the transfer means A5 to the transfer unit (TRS 2) and then carried by the transfer means A5 from the transfer unit (TRS 2) to the heating unit (PEB) in the shelf unit U3. In the developing unit (DEV) forming one tier in the shelf unit U5, the developing solution is supplied to the front surface of the wafer W to develop the resist, whereby a resist mask in a predetermined pattern is formed on the wafer W. Thereafter, the wafer W is returned by the transfer means A1 to the original carrier 8 on the mounting table 80.

What is claimed is:

1. A method of coating a substrate with a resist solution, comprising the steps of:
supplying a front surface of the substrate with a liquid agent for wetting the front surface and rotating the substrate;
subsequently accelerating the substrate to a first number of rotations, and starting supply of the resist solution to a central portion of the substrate during the acceleration to thereby apply the resist solution while spreading the resist solution outward on the substrate;
decelerating the substrate to a second number of rotations after the number of rotations of the substrate reaches the first number of rotations, and rotating the substrate at the second number of rotations to thereby adjust a distribution of the film thickness of the resist solution within a plane;
stopping the supply of the resist solution at a timing when a supply amount of the resist solution while the substrate is accelerated to the first number of rotations becomes 80% or more of a total supply amount; and
thereafter, accelerating the substrate to a third number of rotations higher than the second number of rotations, and rotating the substrate at the third number of rotations to thereby dry a resist film.

2. The resist coating method as set forth in claim 1,
wherein the second number of rotations is 1000 rpm or less.

3. The resist coating method as set forth in claim 1, further comprising:
decelerating the substrate not to the second number of rotations but to the third number of rotations after the number of rotations of the substrate reaches the first number of rotations, and rotating the substrate at the third number of rotations to thereby dry a resist film; and
stopping the supply of the resist solution at a timing when a supply amount of the resist solution while the substrate is accelerated to the first number of rotations becomes 80% or more of a total supply amount.

4. The resist coating method as set forth in claim 1,
wherein the application of the resist solution is started when the substrate is rotated at a number of rotations lower than the third number of rotations.

5. The resist coating method as set forth in claim 3,
wherein the application of the resist solution is started when the substrate is rotated at a number of rotations lower than the third number of rotations.

6. A resist coating apparatus for coating a substrate with a resist solution, comprising:
a substrate holding unit for horizontally holding the substrate;
a rotation drive unit for rotating said substrate holding unit about a vertical axis;
a liquid agent supply unit for supplying a liquid agent for wetting a front surface of the substrate to the substrate held by said substrate holding unit via a liquid agent nozzle;
a resist solution supply unit for supplying a resist solution via a resist solution nozzle to a central portion of the substrate held by said substrate holding unit; and
a controller for controlling said rotation drive unit, said liquid agent supply unit, and said resist solution supply unit to execute a step of supplying a front surface of the substrate with the liquid agent for wetting the front surface and rotating the substrate; a step of subsequently accelerating the substrate to a first number of rotations, and starting supply of the resist solution to the central portion of the substrate during the acceleration to thereby apply the resist solution while spreading the resist solution outward on the substrate; a step of decelerating the substrate to a second number of rotations after the number of rotations of the substrate reaches the first number of rotations, and rotating the substrate at the second number of rotations to thereby adjust a distribution of the film thickness of the resist solution within a plane; a step of stopping the supply of the resist solution at a timing when a supply amount of the resist solution while the substrate is accelerated to the first number of rotations becomes 80% or more of a total supply amount; and a step of thereafter, accelerating the substrate to a third number of rotations higher than the second number of rotations, and rotating the substrate at the third number of rotations to thereby dry a resist film.

7. The resist coating apparatus as set forth in claim 6,
wherein the second number of rotations is 1000 rpm or less.

8. The resist coating apparatus as set forth in claim 6,
wherein said controller controls said rotation drive unit, said liquid agent supply unit, and said resist solution supply unit to execute a step of decelerating the substrate not to the second number of rotations but to the third number of rotations after the number of rotations of the substrate reaches the first number of rotations, and rotating the substrate at the third number of rotations to thereby dry a resist film; and a step of stopping the supply of the resist solution at a timing when a supply amount of the resist solution while the substrate is accelerated to the first number of rotations becomes 80% or more of a total supply amount.

9. The resist coating apparatus as set forth in claim 6,
wherein the application of the resist solution is started when the substrate is rotated at a number of rotations lower than the third number of rotations.

10. The resist coating apparatus as set forth in claim 8,
wherein the application of the resist solution is started when the substrate is rotated at a number of rotations lower than the third number of rotations.

11. A storage medium storing a computer program used in a resist coating apparatus for supplying a resist solution onto a rotating substrate,
said computer program incorporating a step group for causing the resist coating apparatus to perform the steps of:
supplying a front surface of the substrate with a liquid agent for wetting the front surface and rotating the substrate;
subsequently accelerating the substrate to a first number of rotations, and starting supply of the resist solution to a central portion of the substrate during the acceleration to thereby apply the resist solution while spreading the resist solution outward on the substrate;
decelerating the substrate to a second number of rotations after the number of rotations of the substrate reaches the first number of rotations, and rotating the substrate at the second number of rotations to thereby adjust a distribution of the film thickness of the resist solution within a plane;
stopping the supply of the resist solution at a timing when a supply amount of the resist solution while the substrate is accelerated to the first number of rotations becomes 80% or more of a total supply amount; and
thereafter, accelerating the substrate to a third number of rotations higher than the second number of rotations, and rotating the substrate at the third number of rotations to thereby dry a resist film.

12. The storage medium as set forth in claim 11,
wherein said program incorporates a step group for causing the resist coating apparatus to perform the steps of:
decelerating the substrate not to the second number of rotations but to the third number of rotations after the number of rotations of the substrate reaches the first number of rotations, and rotating the substrate at the third number of rotations to thereby dry a resist film; and
stopping the supply of the resist solution at a timing when a supply amount of the resist solution while the substrate is accelerated to the first number of rotations becomes 80 % or more of a total supply amount.
